(19) United States
(12) Patent Application Publication
(10) Pub. No.: US 2022/0030974 A1
(43) Pub. Date: Feb. 3, 2022

(54) FACESHIELD ATTACHMENT FOR EYEWEAR

(71) Applicant: Michael Francis Kane, Costa Mesa, CA (US)

(72) Inventor: Michael Francis Kane, Costa Mesa, CA (US)

(21) Appl. No.: 17/444,045

(22) Filed: Jul. 29, 2021

Related U.S. Application Data
(60) Provisional application No. 63/161,178, filed on Mar. 15, 2021.
(60) Provisional application No. 63/059,788, filed on Jul. 31, 2020.

(51) Int. Cl. A41D 13/11; G02C 11/00

(52) U.S. Cl. CPC A41D 13/1161; G02C 11/00

(57) ABSTRACT

A faceshield for attachment with a bridge portion of a pair of eyewear that includes a shield portion configured to cover a nose portion and a mouth portion of a face. An attachment mechanism, such as a strap or hook, is configured to removably attach with the bridge of the pair of eyewear.

### CROSS REFERENCE

This application claims the benefit of U.S. Provisional Patent Application No. 63/059,788, filed Jul. 31, 2020 and U.S. Provisional Patent Application No. 63/161,178, filed Mar. 15, 2021 the entirety of which are hereby incorporated by reference.

### BACKGROUND

### Field

This disclosure generally relates to improved faceshields.

### Related Art

Available faceshields generally include a built-in headband that attaches around a person's head at the level of the temples and allows arrangement of a shield portion of the faceshield over a person's face.

### SUMMARY

A faceshield including a hook, clasp, or other attachment member for coupling with a bridge portion of a pair of eyewear. A shield portion of the faceshield is configured to cover a nose portion and a mouth portion of a face of the wearer when hanging from the eyewear. The attachment mechanism is formed integrally with or removably couples with an upper end of the shield portion.

### BRIEF DESCRIPTION

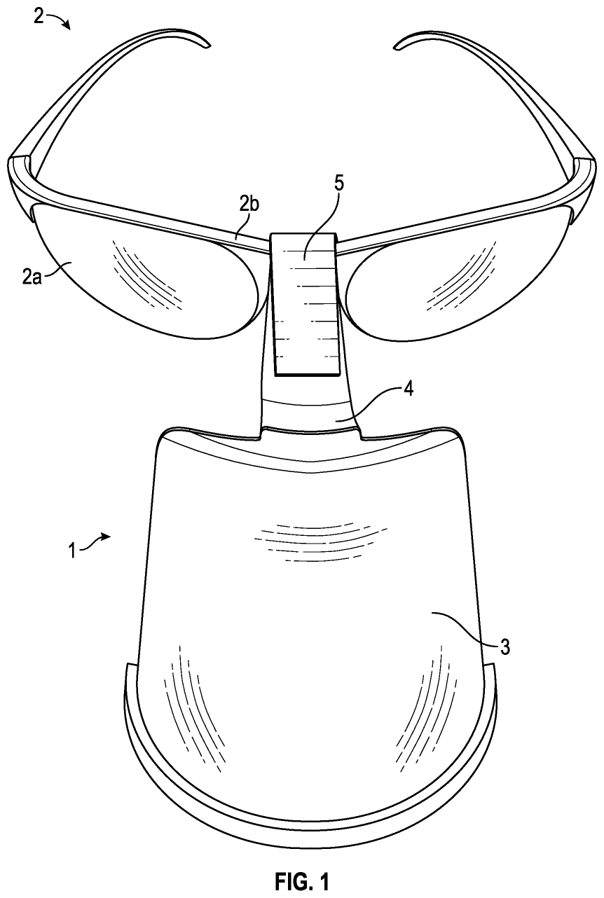

FIG. 1 shows a first embodiment of a faceshield attached with eyewear.

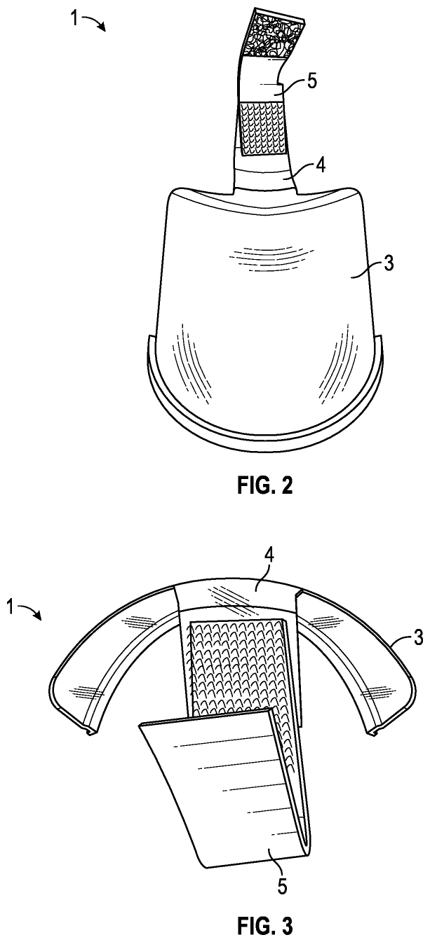

FIG. 2 shows a front view thereof.

FIG. 3 shows a top view thereof.

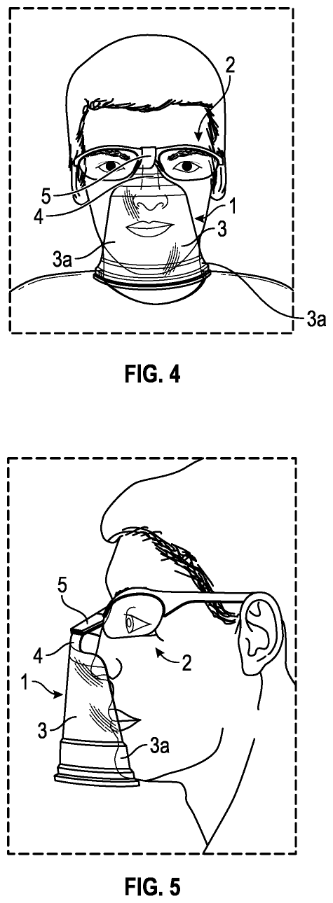

FIGS. 4-5 show the faceshield connected with the eyewear and worn by a wearer.

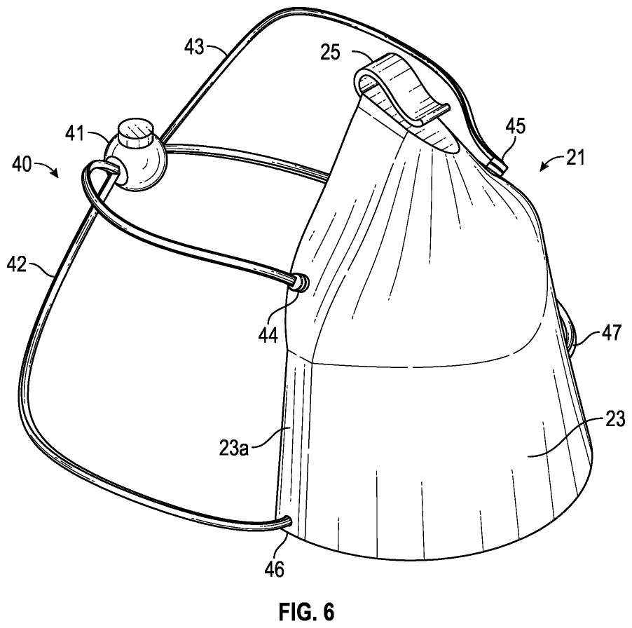

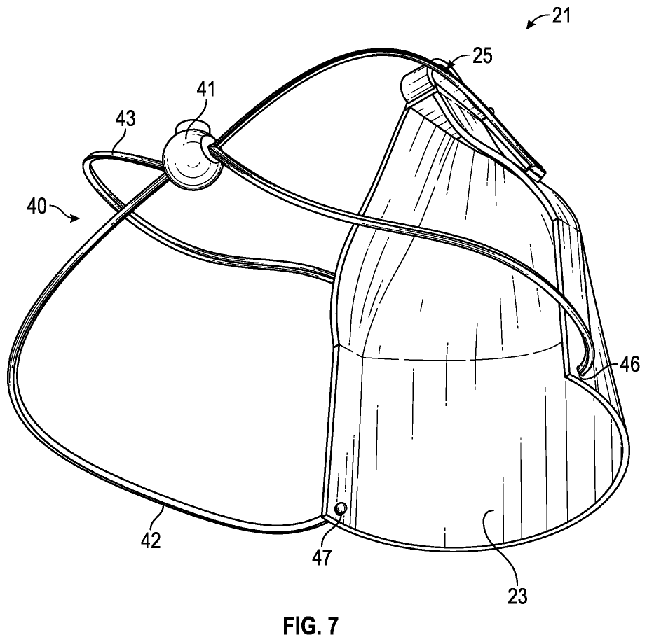

FIG. 6 is a top perspective view of a second embodiment of a faceshield.

FIG. 7 is bottom perspective view thereof.

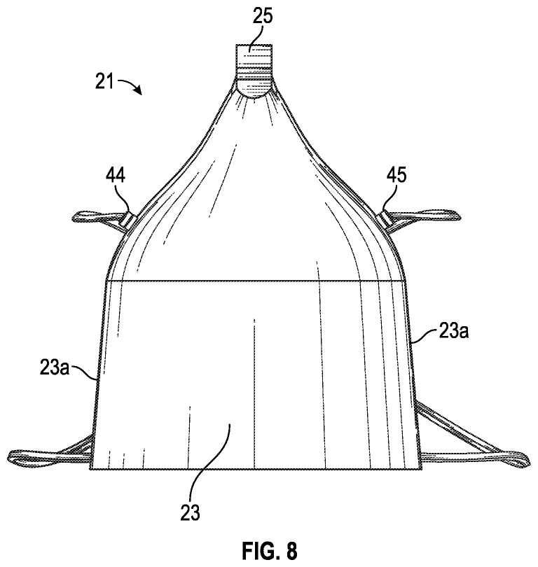

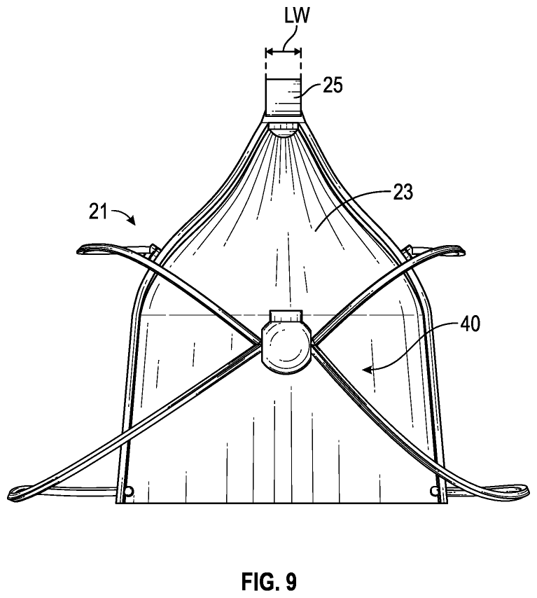

FIG. 8 is a front view thereof.

FIG. 9 is a rear view thereof.

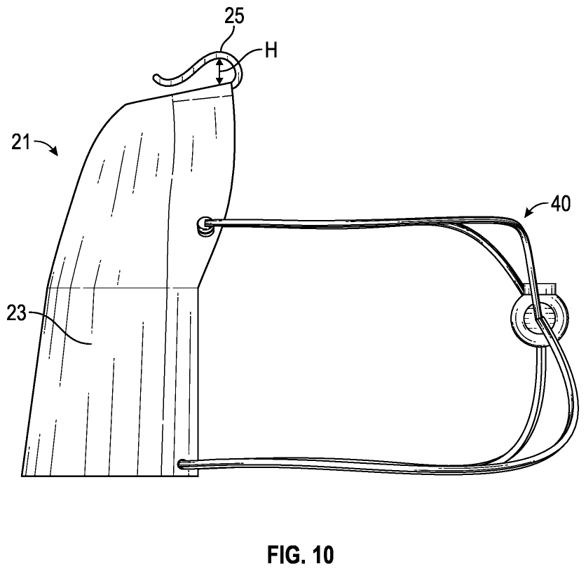

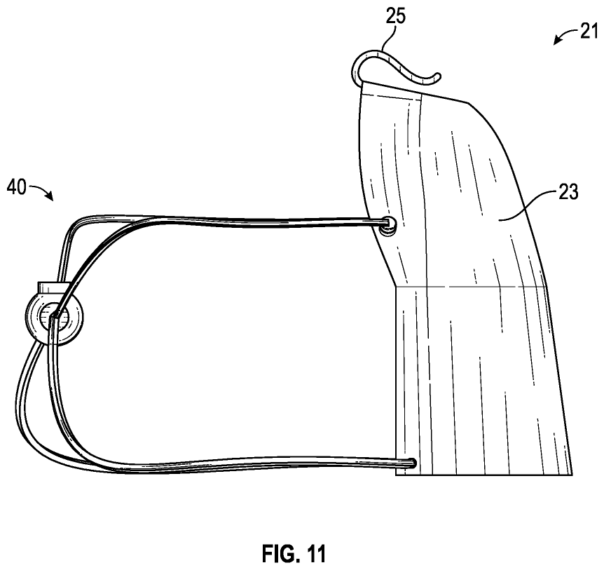

FIG. 10 is a first side view thereof.

FIG. 11 is a second side view thereof.

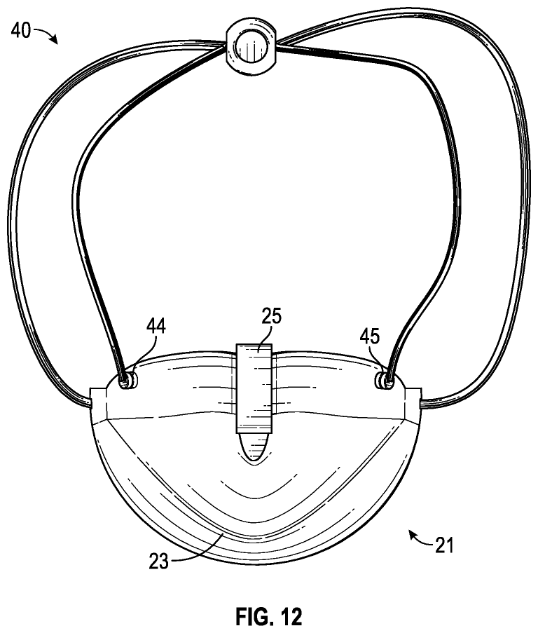

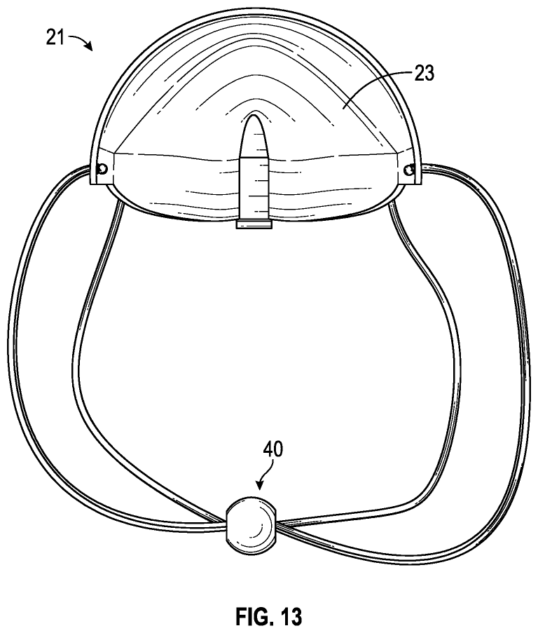

FIG. 12 is a top view thereof.

FIG. 13 is a bottom view thereof.

### DETAILED DESCRIPTION

The present disclosure is directed to a faceshield attachment that easily and/or removably couples with the bridge portion of a pair of eyewear. Many people across the world are accustomed to wearing eyewear such as glasses or sunglasses. In addition, many have been prompted to also wear a mask or faceshield to prevent or slow the spread of infectious diseases. Often the mask or faceshield is not worn constantly but taken on and off when entering and leaving public areas. It is also desirable for the facemask or faceshield to be kept as small and compact as possible. This is especially a problem for faceshields that are large and designed to cover the entire face including the eyes, nose, and mouth. A typical faceshield includes a head strap or headband that wraps all the way around a person's head at the level at the temples and can be adjustable to fit to a person's head. The faceshield can hang down over the person's eyes, nose, and mouth, including any eyewear. However it is also desirable to have a more compact faceshield than the full faceshield.

Accordingly, one of the of the objects of the present disclosure is a faceshield that can attach to an eyewear. The attachment can be removable such that a person can use the eyewear with or without the faceshield and easily switch between the two configuration (e.g., to move between public and nonpublic spaces). The faceshield can be added as an attachment directly to the eyewear. The present disclosure describes a faceshield that includes an attachment mechanism for attaching directly at the bridge of the eyewear between two lenses in an area generally aligned with the bridge of a person's nose.

FIGS. 1-5 illustrates a faceshield 1 connected to a pair of eyewear 2. The eyewear 2 can include a pair of lenses 2a supported by rims. The rims and lenses 2a can be connected by a bridge 2b. Temple extensions can connect with the rims to support the lenses 2a on a person's face. Similarly, the rims/bridge 2b can include nose pads for supporting the eyewear 2 on a person's face. The lenses 2a can be of any style such as prescription or sun lenses. Optionally, the lenses 2a can extend across the bridge 2b (e.g., a mono-lens style eyewear frame).

The faceshield 1 can include a shield portion 3. The shield portion 3 can be sized to generally cover the nose and the mouth of a person's face. As shown further in FIGS. 4 and 5, the shield portion 3 can extend between the nose and the mouth down to a chin on the person's face.

The shield portion 3 can be made from a variety of materials designed to prevent the spread of infectious diseases. The shield portion 3 can be made out of a polymer that prevents the passage air and contaminants therethrough. Alternatively, the shield portion 3 can be made out a porous material that acts as a filter against infectious diseases or other contaminants.

The shield portion 3 can generally be shaped in a convex manner to create an area beneath the shield portion 3 that allows adequate ventilation for a person (e.g., for comfort and respiration). Sides edges 3a of the shield portion 3 can be generally contoured to follow the contours of the person's face. Optionally the side edges 3a can include flexible sealing materials that can aid in preventing the escape of air between the sides edges 3a and the person's face. In certain applications, the shield portion 3 can be made of a variety of materials such as plastics and polymers. The shield portion 3 can be made of a transparent material, non-transparent material or partially-transparent material and combinations thereof. The shield portion 3 and/or the materials thereof can improve facial recognition (e.g., for unlocking computers or phones etc.), visual identification and assisting the hearing impaired with reading lips.

The bottom of the shield portion 3 can be open to allow the passage of ambient air into the area underneath the shield portion 3 and respiration in the reverse direction. The shield portion 3 can direct the person's breath downward (e.g., toward a person's chest) and away from other people that may be in the vicinity.

An upper end of the shield portion 3 can include a connection portion 4. The connection portion 4 can attach between the shield portion 3 and the bridge 2b of the eyewear 2. The connection portion 4 can extend (when worn) inwardly from the tip of the nose towards the bridge of the nose. This can space the shield portion 3 outwardly away from the mouth and/or nose of the person. The connection portion can be coupled or formed integrally with the shield portion 3.

The connection portion 4 can include an attachment mechanism 5. The attachment mechanism 5 can attach the connection portion 4 with the bridge 2b of the eyewear 2. The attachment mechanism 5 can include a strap, clip, hook or other mechanical attachment means. As illustrated, the attachment mechanism 5 is a tether with hook and loop attachment areas that extends over the bridge portion 2b of the eyewear 2. The end of the tether can be reattached to itself via the hook and loop couplings. An opposite end of the tether of the attachment mechanism 5 can be linked or coupled with the connection portion 4 (e.g., directly connected or an integral part of the connection portion 4). As illustrated, a zip tie couples the connection portion 4 with the end of the tether of the attachment mechanism 5.

In certain implementations, the attachment mechanism 5 can fully secure itself to the bridge portion 2a (as in the tether that full encompasses the bridge portion 2). Alternatively, the attachment mechanism can be a hook style that only goes over the bridge portion 2b, but can be removable therefrom without any manipulation of a detachment mechanism (i.e., unclasping the hook and loop connection). The attachment mechanism 5 can also be narrow enough to fit comfortably between the lenses 2a of the eyewear 2 and to avoid any interference with the nose pads that may be part of the eyewear 2.

The shield portion 3 can be smaller than a full faceshield. In combination with eyewear 2, the faceshield 1 can provide the same or similar benefits to the full faceshield by covering both the eyes, nose, and mouth areas of a person. When not in use, the faceshield 1 can be stowed in a compact manner until it is necessary to be used. When its desirable to connect the faceshield 1 the attachment mechanism 5 can be coupled with the bridge portion 2b of the eyewear. Attachment can occur without full removal of the eyewear from the person's face. Similarly, the faceshield 1 can be removed or decoupled from the bridge portion 2b without removal of the eyewear 2.

In an alternative embodiment, the shield portion 3 of the faceshield 1 can extend upwards over the eyes of the person and/or the lenses 2a of the eyewear 2 to provide full face protection.

FIGS. 6-13 shows another embodiment of a faceshield 21. The faceshield 21 The faceshield 21 can include a shield portion 23. The shield portion 23 can be sized to generally cover the nose and the mouth of a person's face. The shield portion 23 can be made from a variety of materials designed to prevent the spread of infectious diseases. The shield portion 23 can be made out of a polymer that prevents the passage air and contaminants therethrough. Alternatively, the shield portion 23 can be made out a porous material that acts as a filter against infectious diseases or other contaminants.

The shield portion 23 can generally be shaped in a convex manner to create an area beneath the shield portion 23 that allows adequate ventilation for person (e.g., for comfort and respiration). Sides edges 23a of the shield portion 23 can be generally contoured to follow the contours of the person's face. Optionally the side edges 23a can include flexible sealing materials that can aid in preventing the escape of air between the sides edges 3a and the person's face.

The bottom of the shield portion 23 can be open to allow the passage of ambient air into the area underneath the shield portion 23 and respiration in the reverse direction. The shield portion 3 can direct the person's breath downward (e.g., toward a person's chest) and away from other people that may be in the vicinity.

An upper end of the shield portion 23 can include an attachment mechanism 25. The attachment mechanism 25 can attach with the bridge of an eyewear. The attachment mechanism 25 is illustrated as a hook formed integrally with the shield portion 23. Alternatively, the attachment mechanism 25 can be a strap, clip, or other mechanical attachment means. The hook can be formed of the same material as the shield portion 23. The hood can include a flexible end member. The flexible end member can be curved outwardly from the shield portion to create a receiving space. The flexible end member can flex outwardly in a compliant manner to receive the bridge of an eyewear within the receiving space. The flexible end member can be positioned over a flattened region of the shield portion. A flared end of the flexible end member can assist a wearer in assembling the hook over the bridge. The hook can have a lateral width LW (left-right in FIG. 8) that is less than or equal to ⅜″ and/or greater than 1/16″. This size can generally fit on the bridge portion of most eyewear. The receiving space can had a maximum height H (e.g., vertical in FIG. 10) that is at least ¼″ and less than ¾″. This size can generally fit on the bridge portion of most eyewear.

The faceshield 21 can include a headstrap assembly 40. The headstrap assembly 40 can attach with the shield portion. The headstrap assembly 40 can be configured to pass around the back of a wearer's head to hold the faceshield on the face of a wearer. The headstrap assembly 40 can enable the shield portion to be worn over the ear as a mask. The headstrap assembly 40 can include an upper strap 43 that attaches with the shield portion 23 at ends 44, 45. The ends 44, 45 can include connectors for attachment with the shield portion 23. The connectors can optionally be ties, clasps, buttons, hooks, magnetic clasps, or other mechanical fasteners. The headstrap assembly 40 can include a lower strap 42 that attaches with the shield portion 23 at ends 46, 46. The ends 46, 47 can include connectors for attachment with the shield portion 23. The connectors can optionally be ties, clasps, buttons, hooks, magnetic clasps, or other mechanical fasteners. The length of the straps 42, 43 can be adjustable. The headstrap assembly 40 can include a connector 41, such as a spring toggle, for adjusting lengths of the straps 42, 43.

### Certain Terminology

Terms of orientation used herein, such as “top,” “bottom,” “proximal,” “distal,” “longitudinal,” “lateral,” and “end,” are used in the context of the illustrated example. However, the present disclosure should not be limited to the illustrated orientation. Indeed, other orientations are possible and are within the scope of this disclosure. Terms relating to circular shapes as used herein, such as diameter or radius, should be understood not to require perfect circular structures, but rather should be applied to any suitable structure with a cross-sectional region that can be measured from side-to-side. Terms relating to shapes generally, such as “circular,” “cylindrical,” “semi-circular,” or “semi-cylindrical” or any related or similar terms, are not required to conform strictly to the mathematical definitions of circles or cylinders or other structures, but can encompass structures that are reasonably close approximations.

Conditional language, such as “can,” “could,” “might,” or “may,” unless specifically stated otherwise, or otherwise understood within the context as used, is generally intended to convey that certain examples include or do not include, certain features, elements, and/or steps. Thus, such conditional language is not generally intended to imply that features, elements, and/or steps are in any way required for one or more examples.

Conjunctive language, such as the phrase “at least one of X, Y, and Z,” unless specifically stated otherwise, is otherwise understood with the context as used in general to convey that an item, term, etc. may be either X, Y, or Z. Thus, such conjunctive language is not generally intended to imply that certain examples require the presence of at least one of X, at least one of Y, and at least one of Z.

The terms “approximately,” “about,” and “substantially” as used herein represent an amount close to the stated amount that still performs a desired function or achieves a desired result. For example, in some examples, as the context may dictate, the terms “approximately,” “about,” and “substantially,” may refer to an amount that is within less than or equal to 10% of the stated amount. The term “generally” as used herein represents a value, amount, or characteristic that predominantly includes or tends toward a particular value, amount, or characteristic. As an example, in certain examples, as the context may dictate, the term “generally parallel” can refer to something that departs from exactly parallel by less than or equal to 20 degrees. All ranges are inclusive of endpoints.

### SUMMARY

Several illustrative examples of faceshields have been disclosed. Although this disclosure has been described in terms of certain illustrative examples and uses, other examples and other uses, including examples and uses which do not provide all of the features and advantages set forth herein, are also within the scope of this disclosure. Components, elements, features, acts, or steps can be arranged or performed differently than described and components, elements, features, acts, or steps can be combined, merged, added, or left out in various examples. All possible combinations and subcombinations of elements and components described herein are intended to be included in this disclosure. No single feature or group of features is necessary or indispensable.

Certain features that are described in this disclosure in the context of separate implementations can also be implemented in combination in a single implementation. Conversely, various features that are described in the context of a single implementation also can be implemented in multiple implementations separately or in any suitable subcombination. Moreover, although features may be described above as acting in certain combinations, one or more features from a claimed combination can in some cases be excised from the combination, and the combination may be claimed as a subcombination or variation of a sub combination.

Further, while illustrative examples have been described, any examples having equivalent elements, modifications, omissions, and/or combinations are also within the scope of this disclosure. Moreover, although certain aspects, advantages, and novel features are described herein, not necessarily all such advantages may be achieved in accordance with any particular example. For example, some examples within the scope of this disclosure achieve one advantage, or a group of advantages, as taught herein without necessarily achieving other advantages taught or suggested herein. Further, some examples may achieve different advantages than those taught or suggested herein.

Some examples have been described in connection with the accompanying drawings. The figures are drawn and/or shown to scale, but such scale should not be limiting, since dimensions and proportions other than what are shown are contemplated and are within the scope of the disclosed invention. Distances, angles, etc. are merely illustrative and do not necessarily bear an exact relationship to actual dimensions and layout of the devices illustrated. Components can be added, removed, and/or rearranged. Further, the disclosure herein of any particular feature, aspect, method, property, characteristic, quality, attribute, element, or the like in connection with various examples can be used in all other examples set forth herein. Additionally, any methods described herein may be practiced using any device suitable for performing the recited steps.

For purposes of summarizing the disclosure, certain aspects, advantages and features of the inventions have been described herein. Not all, or any such advantages are necessarily achieved in accordance with any particular example of the inventions disclosed herein. No aspects of this disclosure are essential or indispensable. In many examples, the devices may be configured differently than illustrated in the figures or description herein. For example, various functionalities provided by the illustrated modules can be combined, rearranged, added, or deleted. In some implementations, additional or different processors or modules may perform some or all of the functionalities described with reference to the examples described and illustrated in the figures. Many implementation variations are possible. Any of the features, structures, steps, or processes disclosed in this specification can be included in any example.

In summary, various examples of faceshields have been disclosed. This disclosure extends beyond the specifically disclosed examples to other alternative examples and/or other uses of the examples, as well as to certain modifications and equivalents thereof. Moreover, this disclosure expressly contemplates that various features and aspects of the disclosed examples can be combined with, or substituted for, one another. Accordingly, the scope of this disclosure should not be limited by the particular disclosed examples described above, but should be determined only by a fair reading of the claims.

What is claimed is:

1. A faceshield for attachment with a bridge portion of a pair of eyewear, comprising:
a shield portion configured to cover a nose portion and a mouth portion of a face; and
an attachment mechanism, the attachment mechanism removably coupled with an upper end of the shield portion.

2. The faceshield of claim 1, wherein the attachment mechanism is a hook.

3. The faceshield of claim 2, wherein the hook is integrally formed with the shield portion.

4. The faceshield of claim 2, wherein the hook is configured to flex compliantly to receive the bridge portion within a receiving space.

5. The faceshield of claim 4, wherein the receiving space has a height between ¼″ and ¾″.

6. The faceshield of claim 2, wherein the hook has a lateral width less than ⅜″ and greater than 1/16″ to fit on the bridge portion.

7. The faceshield of claim 2, wherein an end portion of the hook includes a flared portion.

8. The faceshield of claim 1, further comprising a headstrap assembly.

9. The faceshield of claim 8, wherein headstrap assembly includes an upper strap with one or more magnetic connectors coupling with the shield portion.

10. The faceshield of claim 8, wherein headstrap assembly includes an upper strap and a lower strap coupled by an adjustable connector.

11. The faceshield of claim 1, wherein the attachment mechanism is a hook-and-loop strap.

12. The faceshield of claim 1, wherein edges of the shield portion include a flexible seal configured to engage with a face of a wearer.

13. The faceshield of claim 1, wherein opposing edges of the shield portion are contoured to follow along a cheek portion of a wearer's face.

14. The faceshield of claim 1, wherein a bottom portion of the shield portion is configured to be open to allow passage of gases to a wearer.

15. The faceshield of claim 1, wherein the attachment mechanism includes a strap.
